(19) United States
(12) Patent Application Publication
(10) Pub. No.: US 2003/0230924 A1
(43) Pub. Date: Dec. 18, 2003

(54) E-Z lift : ergonomic back saving motorized unloader for utility/laundry carts

(76) Inventor: Slobodan Davidovic, Weymouth, MA (US)

Correspondence Address: SLOBODAN DAVIDOVIC, 79 DONALD ST. APT.311, WEYMOUTH, MA, 02188, US

(21) Appl. No.: 10/170,844

(22) Filed: Jun. 13, 2002

(51) Int. Cl. B60P 1/00

(52) U.S. Cl. 298/1 B

(57) ABSTRACT

The patent is technical in nature. It is heavy duty canvas in the steel frame. Frame is placed on top of the cart. One side of the canvas is fixed to the frame and the other end is attached to a steel tube-powered by tubular electric motor. Unwinding the canvas around the tube canvas goes to the bottom of the cart so that it can be loaded with laundry, and winding it in opposite direction bringing up the contest of the cart. If let work with button pressed all the time it will virtually unload itself.

### CROSS-REFERENCE TO RELATED APPLICATIONS

There has been never even similar application to solve the problem of unloading laundry carts by bending down to pick up from the bottom, one by one piece of laundry.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Friend of mine, the owner of Dry Cleaning establishment came to me with back pain and said he cannot stand it anymore. Also his workers complained of back pain from unloading laundry carts. They have to bend every time to pick up from the bottom of the cart piece by piece of laundry. At average they have to unload 18 carts a day (average full bends per cart—15). The only device in the market is spring loaded platform that lifts only 50% of the high of the cart and only few last light items, it is highly unreliable and basically useless.

This is one of the biggest problems in Dry Cleaning/Laundry industries. Good workers are leaving with back injures and medical bills are souring. My invention, E-Z LIFT solves the problem 100% by enabling the workers to unload the carts without any bending (not even lean towards the cart).

### BRIEF SUMMARY OF THE INVENTION

One of the biggest if not The biggest problem in Dry Cleaning Industry and also in service industry, where one has to unload utility/laundry cart with hands by picking piece-by-piece from the cart, is bending, which leads to back injuries and loss of good workers. And that leads to souring medical bills.

I solved the problem by enabling the worker, he/she, to unload a cart (every single piece) by standing up right through all process and NOT bend an inch.

Object of the invention is to eliminate totally and completely back injuries in Dry Cleaning Industry. One can only imagine the benefits for the industry by preventing injuries and money savings.

### BRIEF DESCRIPTION OF THE SEVERAL VIEWS OF THE DRAWINGS

Pg. 1-4

Shows perspective view—suitable for Front Page

Pg. 2-4

FIG. 1 . . . Shows E-Z LIFT in relation with utility cart. Actual working position.

Pg. 3-4

FIG. 2 . . . Shows Power Axle, which consist of:

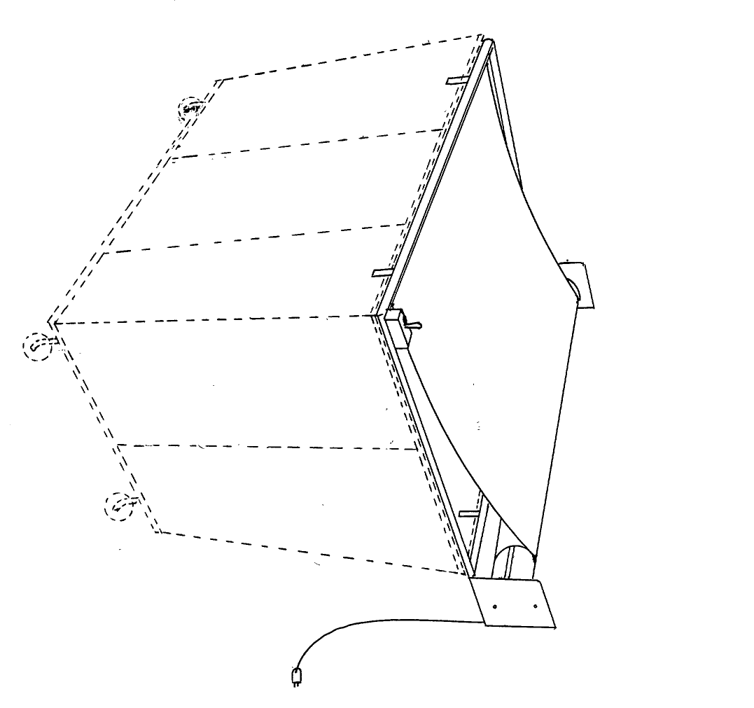

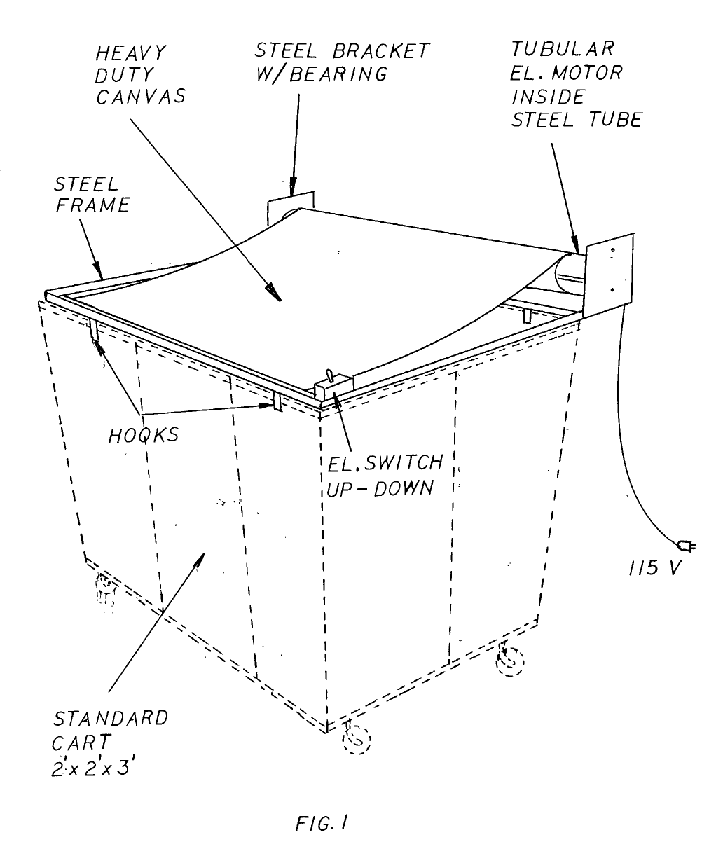

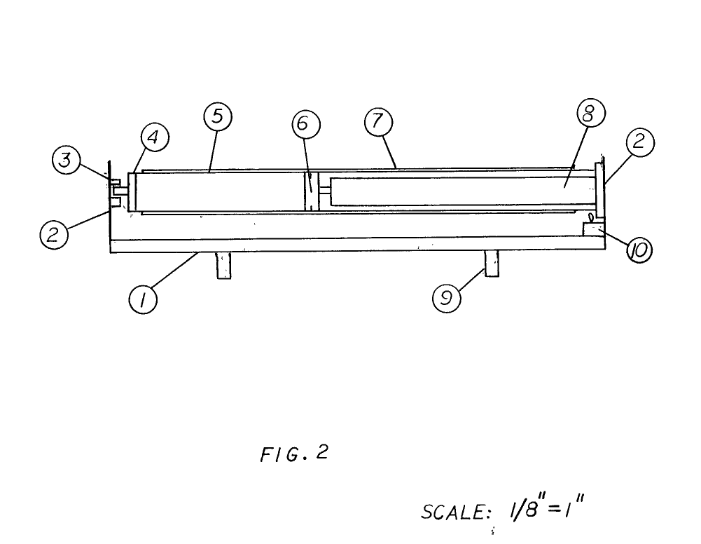

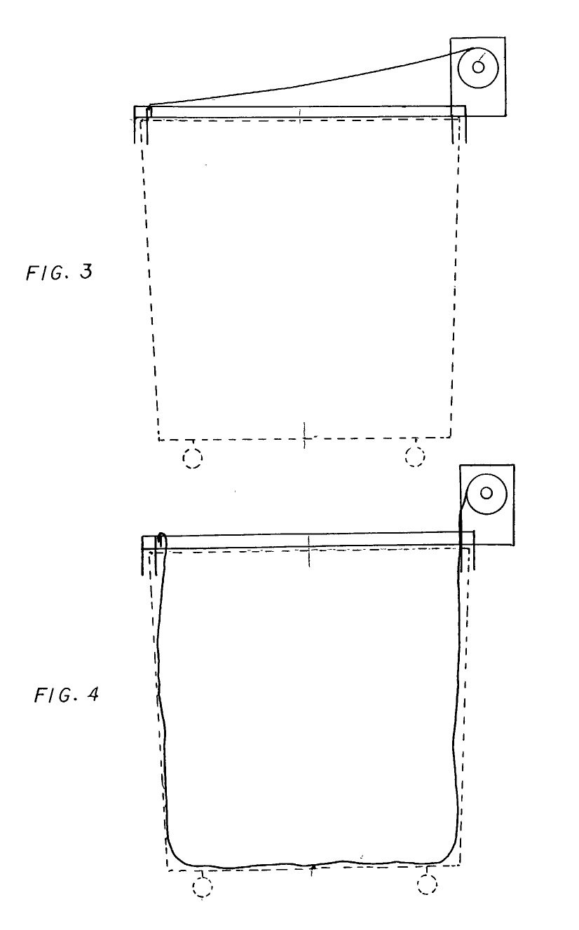

1—steel frame, square tube 1″×1″×14 ga

2—steel brackets—one for motor head, one for bearing—4″×6″×⅛″

3—bearing—½″

4—crown (insert for the steel tube to fit in a bearing), dia. 3″

5—galvanized steel tube, dia 3″, with grove for plastic wire to attach canvas

6—crown—3″, insert that attach motor to steel tube, so that tube can rotate around the motor

7—heavy duty canvas, attached to a steel tube 30″×7′

8—tubular motor—120V, 0.7A, 80W, nominal torque 88 in.lb, theoretical lifting capacity 88 lbs, with brake and limit switch

9—U-hooks, to fit on the frame of the cart

10—electric switch, maintained with “up” and “down” positions

Pg. 4-4

FIG. 3 . . . shows “up” positions, after unloading

FIG. 4 . . . shows “down” position, ready for loading

### DETAILED DESCRIPTION OF THE INVENTION

E-Z LIFT is made of steel tubes welded together in rectangle shape. Underneath the tubes two steel hooks—U-shaped are welded to fit on the frame of utility/laundry cart. No rough edges. Heavy duty canvas is fixed to one side of the frame and attached on the opposite side of the frame to a steel tube by plastic wire in the grove. Steel tube is powered by tubular motor which is controlled by electric switch, attached to the frame, with “up” and “down” positions. For safety reasons it is maintained switch—has to be pressed all the time, for motor to run. Power axle—tubular motor installed in a steel tube, sits in two steel brackets. One side for the motor head and the other for a bearing.

E-Z LIFT is portable, weights about 20 Lbs, and is very easy to fit on the frame of the cart and switch from one cart to another, as job requires. It is secured in place by U-shaped steel hooks. By pressing the el. switch “down”, canvas unwind on power axle and goes down in the cart, towards the bottom, thus spreading itself on the inner walls and bottom of the cart—providing space for the full capacity of the cart to be used. Cart is than loaded with laundry and pushed to unloading location (racks or ironing) where it is to be unloaded piece by piece. A worker, he/she, starts unloading in their ergonomically ideal position—that is upright. As soon as the level of the load drops to the level that asks for a bend (which depends of the height of the worker), he/she will pres the el. switch “up” and power axle (motor in the tube) will wind the canvas and lift the contest of the cart to desired level. Canvas will go as far as top of the cart and is controlled by limit switch—incorporated in the el. motor.

A worker has full control of the unloading speed. After unloading canvas is lowered down and cart is ready for another load.

1. What I claim as my invention is: E-Z LIFT, ergonomic motorized unloader for the utility/laundry carts. It is achieved by winding heavy duty canvas, attached to the opposite side of the cart, around the steel tube thus lifting the contest of the cart up to be picked by person without any bend in the waist.
